(19) United States
(12) Patent Application Publication
(10) Pub. No.: US 2024/0155591 A1
(43) Pub. Date: May 9, 2024

(54) TECHNIQUES FOR CONFIGURING SUB-BAND FULL DUPLEX RESOURCES

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Qian ZHANG, Basking Ridge, NJ (US); Jing SUN, San Diego, CA (US)

(21) Appl. No.: 18/359,609

(22) Filed: Jul. 26, 2023

Related U.S. Application Data
(60) Provisional application No. 63/382,236, filed on Nov. 3, 2022.

(51) Int. Cl. H04W 72/0457; H04W 72/0453; H04W 72/1273

(52) U.S. Cl. CPC H04W 72/0457; H04W 72/0453; H04W 72/1273

(57) ABSTRACT

Various aspects of the present disclosure generally relate to wireless communication. In some aspects, a user equipment (UE) may receive a first configuration of at least one of an uplink bandwidth part (BWP) or a downlink BWP. The UE may receive a second configuration of at least one of an uplink sub-band or a downlink sub-band. The UE may identify at least one of frequency resources associated with transmitting an uplink communication or frequency resources associated with receiving a downlink communication based at least in part on the first configuration and the second configuration. Numerous other aspects are described.

### CROSS-REFERENCE TO RELATED APPLICATION

This Patent application claims priority to U.S. Provisional Patent Application No. 63/382,236, filed on Nov. 3, 2022, entitled TECHNIQUES FOR CONFIGURING SUB-BAND FULL DUPLEX RESOURCES,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for configuring sub-band full duplex resources.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include receiving a first configuration of at least one of an uplink bandwidth part (BWP) or a downlink BWP. The method may include receiving a second configuration of at least one of an uplink sub-band or a downlink sub-band. The method may include identifying at least one of frequency resources associated with transmitting an uplink communication or frequency resources associated with receiving a downlink communication based at least in part on the first configuration and the second configuration.

Some aspects described herein relate to a method of wireless communication performed by a network node. The method may include transmitting a first configuration of at least one of an uplink BWP or a downlink BWP. The method may include transmitting a second configuration of at least one of an uplink sub-band or a downlink sub-band. The method may include identifying at least one of frequency resources associated with receiving an uplink communication or frequency resources associated with transmitting a downlink communication based at least in part on the first configuration and the second configuration.

Some aspects described herein relate to a UE for wireless communication. The UE may include one or more memories and one or more processors coupled to the one or more memories. The one or more processors, individually or collectively, may be configured to receive a first configuration of at least one of an uplink BWP or a downlink BWP. The one or more processors, individually or collectively, may be configured to receive a second configuration of at least one of an uplink sub-band or a downlink sub-band. The one or more processors, individually or collectively, may be configured to identify at least one of frequency resources associated with transmitting an uplink communication or frequency resources associated with receiving a downlink communication based at least in part on the first configuration and the second configuration.

Some aspects described herein relate to a network node for wireless communication. The network node may include one or more memories and one or more processors coupled to the one or more memories. The one or more processors, individually or collectively, may be configured to transmit a first configuration of at least one of an uplink BWP or a downlink BWP. The one or more processors, individually or collectively, may be configured to transmit a second configuration of at least one of an uplink sub-band or a downlink sub-band. The one or more processors, individually or collectively, may be configured to identify at least one of frequency resources associated with receiving an uplink communication or frequency resources associated with transmitting a downlink communication based at least in part on the first configuration and the second configuration.

Some aspects described herein relate to a non-transitory computer-readable medium that stores a set of instructions for wireless communication by a UE. The set of instructions, when executed by one or more processors of the UE, may cause the UE to receive a first configuration of at least one of an uplink BWP or a downlink BWP. The set of instructions, when executed by one or more processors of the UE, may cause the UE to receive a second configuration of at least one of an uplink sub-band or a downlink sub-band. The set of instructions, when executed by one or more processors of the UE, may cause the UE to identify at least one of frequency resources associated with transmitting an uplink communication or frequency resources associated with receiving a downlink communication based at least in part on the first configuration and the second configuration.

Some aspects described herein relate to a non-transitory computer-readable medium that stores a set of instructions for wireless communication by a network node. The set of instructions, when executed by one or more processors of the network node, may cause the network node to transmit a first configuration of at least one of an uplink BWP or a downlink BWP. The set of instructions, when executed by one or more processors of the network node, may cause the network node to transmit a second configuration of at least one of an uplink sub-band or a downlink sub-band. The set of instructions, when executed by one or more processors of the network node, may cause the network node to identify at least one of frequency resources associated with receiving an uplink communication or frequency resources associated with transmitting a downlink communication based at least in part on the first configuration and the second configuration.

Some aspects described herein relate to an apparatus for wireless communication. The apparatus may include means for receiving a first configuration of at least one of an uplink BWP or a downlink BWP. The apparatus may include means for receiving a second configuration of at least one of an uplink sub-band or a downlink sub-band. The apparatus may include means for identifying at least one of frequency resources associated with transmitting an uplink communication or frequency resources associated with receiving a downlink communication based at least in part on the first configuration and the second configuration.

Some aspects described herein relate to an apparatus for wireless communication. The apparatus may include means for transmitting a first configuration of at least one of an uplink BWP or a downlink BWP. The apparatus may include means for transmitting a second configuration of at least one of an uplink sub-band or a downlink sub-band. The apparatus may include means for identifying at least one of frequency resources associated with receiving an uplink communication or frequency resources associated with transmitting a downlink communication based at least in part on the first configuration and the second configuration.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network.

FIG. 2 is a diagram illustrating an example of a network node in communication with a user equipment (UE) in a wireless network.

FIG. 3 is a diagram illustrating an example disaggregated base station architecture, in accordance with the present disclosure.

FIGS. 4A-4C are diagrams illustrating examples of full duplex communication in accordance with the present disclosure.

FIG. 5 is a diagram illustrating examples of full-duplex communication in a wireless network, in accordance with the present disclosure.

FIG. 6 is a diagram illustrating an example of a sub-band full duplex slot format, in accordance with the present disclosure.

FIG. 7 is a diagram of an example associated with configuring sub-band full duplex resources, in accordance with the present disclosure.

FIG. 8 is a diagram illustrating an example process performed, for example, by a UE, in accordance with the present disclosure.

FIG. 9 is a diagram illustrating an example process performed, for example, by a network node, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

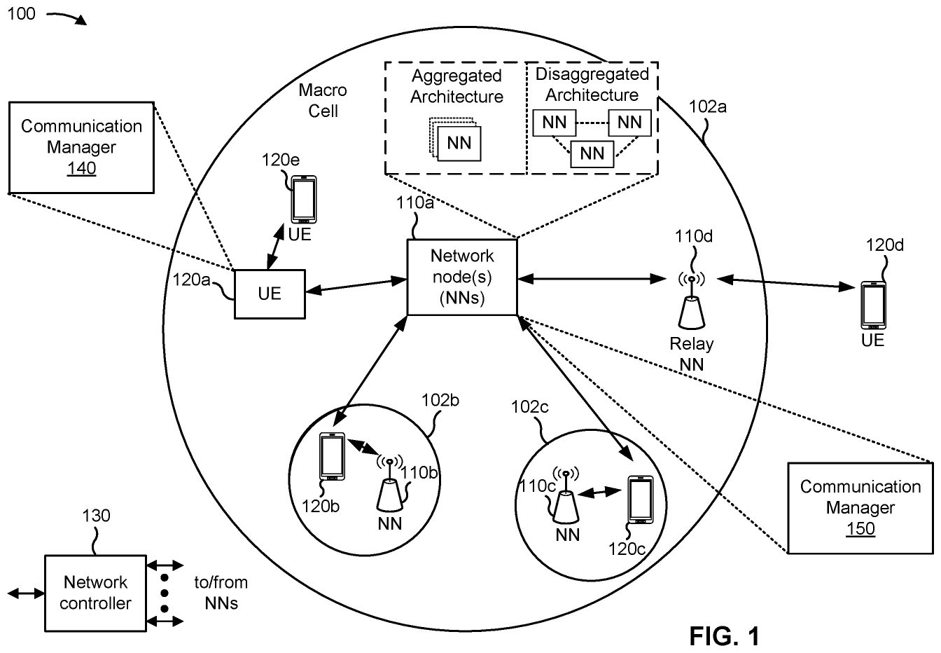

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a first configuration of at least one of an uplink bandwidth part (BWP) or a downlink BWP; receive a second configuration of at least one of an uplink sub-band or a downlink sub-band; and identify at least one of frequency resources associated with transmitting an uplink communication or frequency resources associated with receiving a downlink communication based at least in part on the first configuration and the second configuration. Additionally, or alternatively, the communication manager 140 may perform one or more other operations described herein.

In some aspects, the network node 110 may include a communication manager 150. As described in more detail elsewhere herein, the communication manager 150 may transmit a first configuration of at least one of an uplink BWP or a downlink BWP; transmit a second configuration of at least one of an uplink sub-band or a downlink sub-band; and identify at least one of frequency resources associated with receiving an uplink communication or frequency resources associated with transmitting a downlink communication based at least in part on the first configuration and the second configuration. Additionally, or alternatively, the communication manager 150 may perform one or more other operations described herein.

As indicated above, FIG. 1 is provided as an example. Other examples may differ from what is described with regard to FIG. 1.

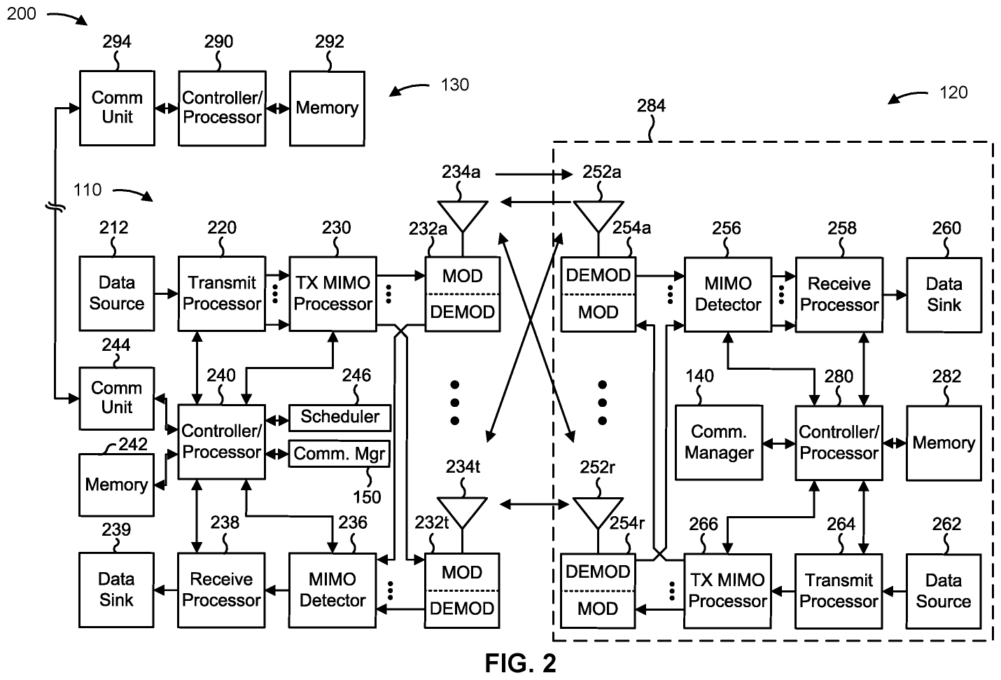

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

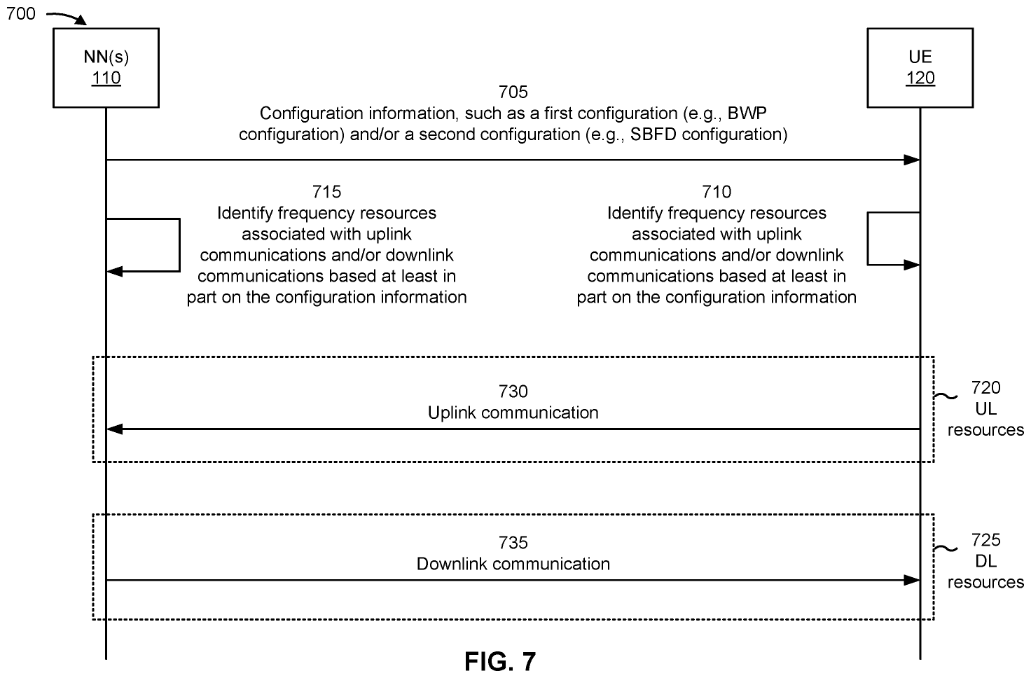

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 7-11).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 7-11).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

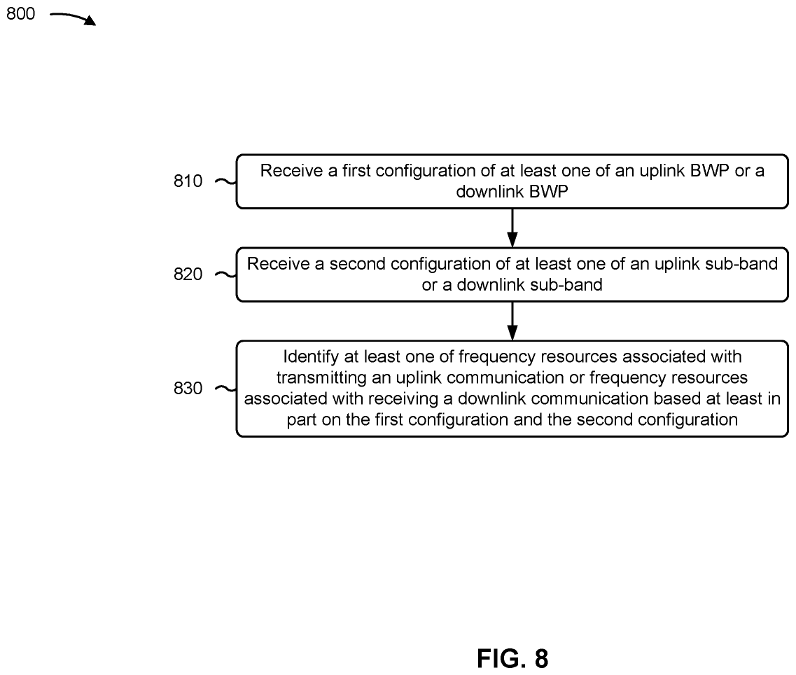

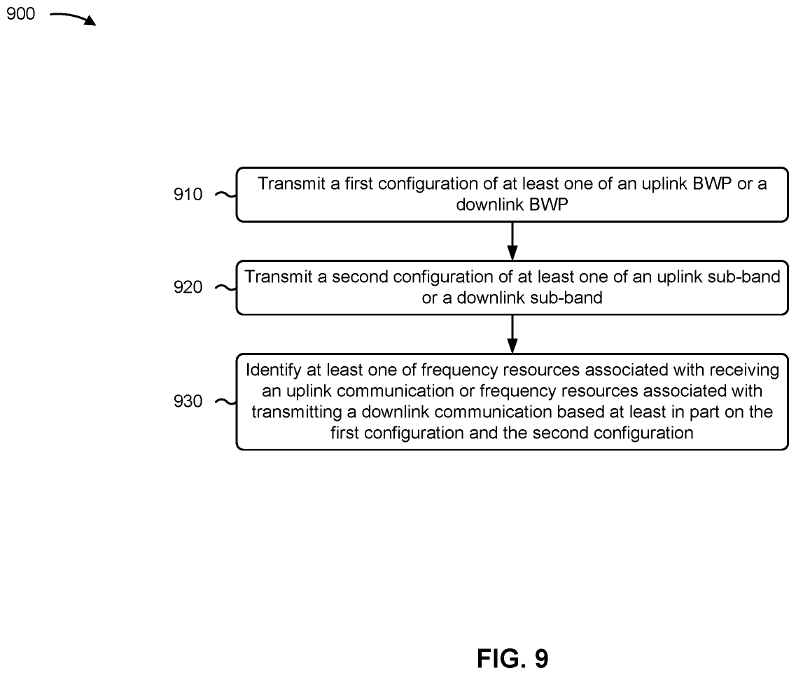

The controller/processor 240 of the network node 110, the controller/processor 280 of the UE 120, or any other component(s) of FIG. 2 may perform one or more techniques associated with configuring sub-band full duplex resources, as described in more detail elsewhere herein. For example, the controller/processor 240 of the network node 110, the controller/processor 280 of the UE 120, or any other component(s) (or combinations of components) of FIG. 2 may perform or direct operations of, for example, process 800 of FIG. 8, process 900 of FIG. 9, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE 120 includes means for receiving a first configuration of at least one of an uplink BWP or a downlink BWP; means for receiving a second configuration of at least one of an uplink sub-band or a downlink sub-band; and/or means for identifying at least one of frequency resources associated with transmitting an uplink communication or frequency resources associated with receiving a downlink communication based at least in part on the first configuration and the second configuration. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting a first configuration of at least one of an uplink BWP or a downlink BWP; means for transmitting a second configuration of at least one of an uplink sub-band or a downlink sub-band; and/or means for identifying at least one of frequency resources associated with receiving an uplink communication or frequency resources associated with transmitting a downlink communication based at least in part on the first configuration and the second configuration. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

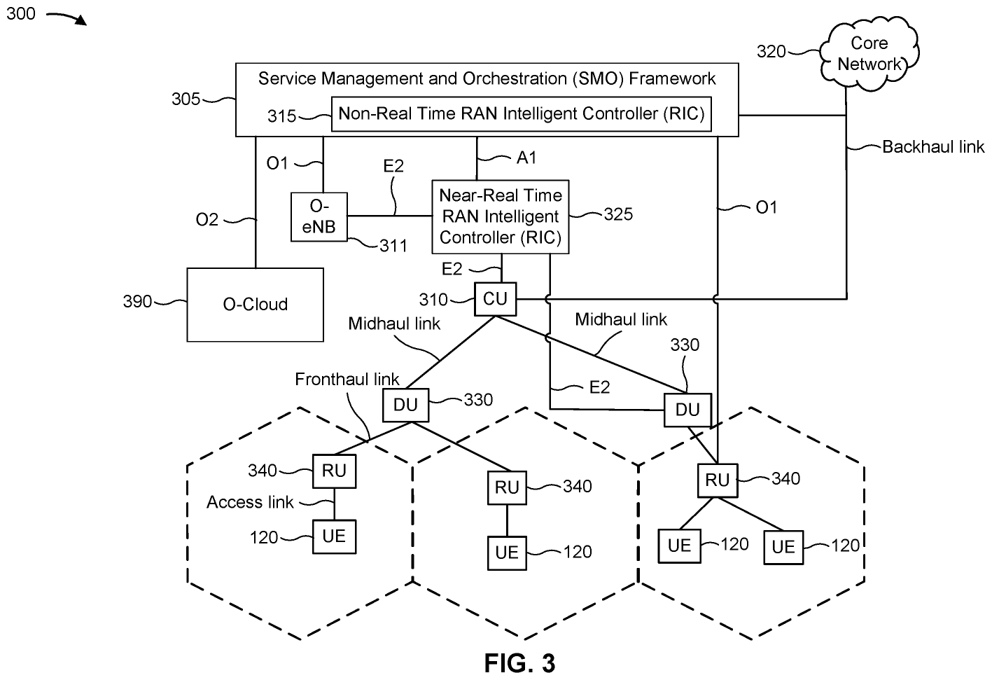

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

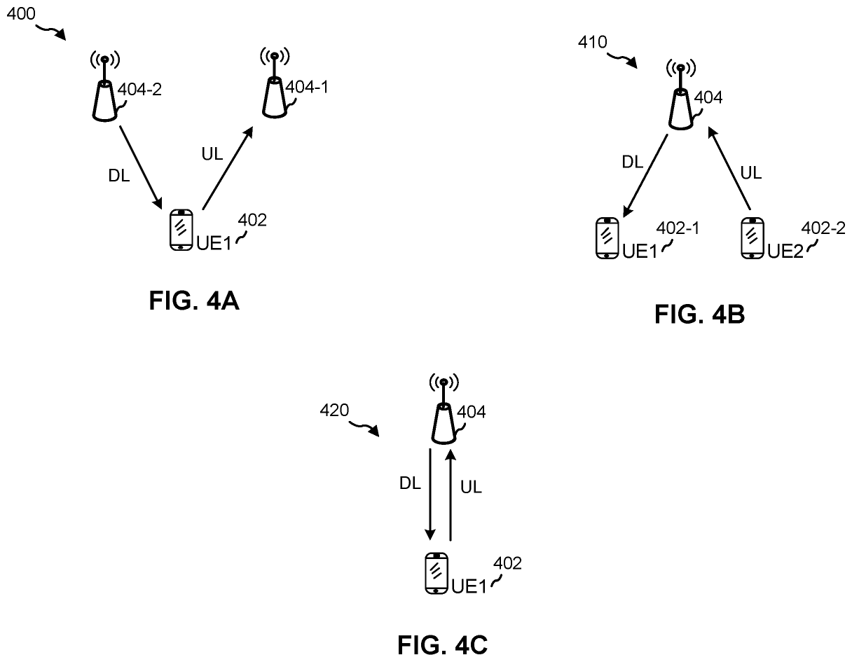

FIGS. 4A-4C are diagrams illustrating examples 400, 410, 420 of full duplex (FD) communication in accordance with the present disclosure. FD communication in a wireless network refers to simultaneous bi-directional communication between devices in the wireless network. For example, a UE operating in an FD mode may transmit an uplink communication and receive a downlink communication at the same time (e.g., in the same slot or the same symbol). Half duplex (HD) communication in a wireless network refers to unidirectional communications (e.g., only downlink communication or only uplink communication) between devices at a given time (e.g., in a given slot or a given symbol).

The example 400 of FIG. 4A includes a UE1 402 (e.g., UE 120) and two network nodes (e.g., TRPs) 404-1, 404-2 (e.g., network nodes 110), where the UE1 402 is sending UL transmissions to the network node 404-1 and is receiving DL transmissions from the network node 404-2. In the example 400 of FIG. 4A, FD is enabled for the UE1 402, but not for the network nodes 404-1, 404-2. Put another way, the network nodes 404-1, 404-2 are operating in an HD mode. The example 410 of FIG. 4B includes two UEs, shown as UE1 402-1 and UE2 402-2, and a network node 404, where the UE1 402-1 is receiving a DL transmission from the network node 404 and the UE2 402-2 is transmitting an UL transmission to the network node 404. In the example 410 of FIG. 4B, FD is enabled for the network node 404, but not for the UE1 402-1 and the UE2 402-2 (e.g., the UE1 402-1 and the UE2 402-2 are operating in an HD mode). The example 420 of FIG. 4C includes a UE1 402 and a network node 404, where the UE1 402 is receiving a DL transmission from the network node 404 and the UE1 402 is transmitting an UL transmission to the network node 404. In the example 420 of FIG. 4C, FD is enabled for both the UE1 402 and the network node 404.

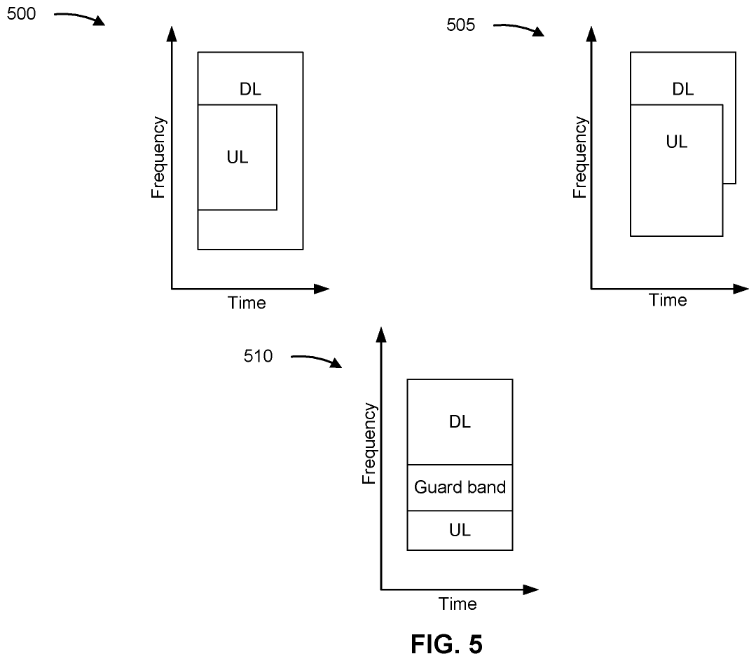

In some examples, a wireless communication device operating in an 1-D mode (e.g., the UE1 402 in examples 400 and/or 420, and/or the network node 404 in examples 410 and/or 420), may be operating in an in-band full duplex (IBFD) mode or a sub-band full duplex (SBFD) mode. In an IBFD mode, a wireless communication device may transmit and receive communications on the same time and frequency resources (e.g., DL resources and UL resources may at least partially overlap in the time and frequency domains). In an SBFD mode, a wireless communication device may transmit and receive communications at the same time but on different frequency resources. In such examples, a DL resource may be separated from an UL resource by a guard band. Examples of IBFD operation and SBFD operation are described in more detail below in connection with FIG. 5.

As indicated above, FIGS. 4A-4C are provided as one or more examples. Other examples may differ from what is described with regard to FIGS. 4A-4C.

FIG. 5 is a diagram illustrating examples 500, 505, and 510 of full-duplex communication in a wireless network, in accordance with the present disclosure.

As shown in FIG. 5, examples 500 and 505 show examples of IBFD communication. In IBFD, a UE may transmit an uplink communication to a network node and receive a downlink communication from the network node on the same time and frequency resources. As shown in example 500, in a first example of IBFD, the time and frequency resources for uplink communication may fully overlap with the time and frequency resources for downlink communication. As shown in example 505, in a second example of IBFD, the time and frequency resources for uplink communication may partially overlap with the time and frequency resources for downlink communication.

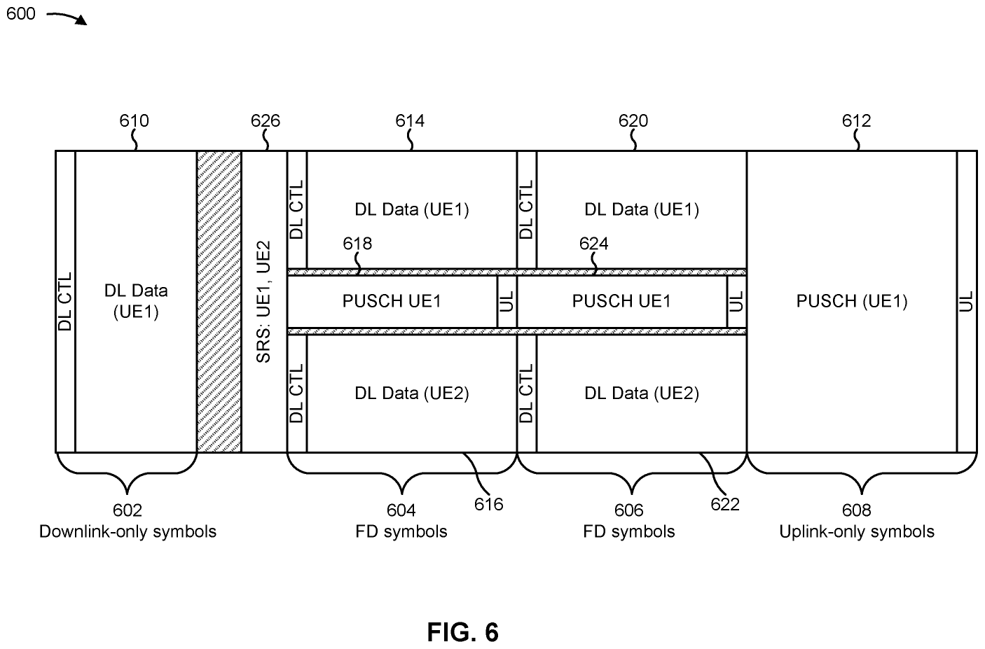

As further shown in FIG. 5, example 510 shows an example of SBFD communication, which may also be referred to as sub-band frequency division duplex (SBFDD) or flexible duplex. In SBFD, a network node may transmit a downlink communication to a UE and receive an uplink communication from the same UE or a different UE at the same time, but on different frequency resources. For example, the different frequency resources may be sub-bands of a frequency band, such as a time division duplexing (TDD) band. In this case, the frequency resources used for downlink communication may be separated from the frequency resources used for uplink communication, in the frequency domain, by a guard band. An example SBFD slot structure is described in more detail below in connection with FIG. 6

As indicated above, FIG. 5 is provided as an example. Other examples may differ from what is described with respect to FIG. 5.

FIG. 6 is a diagram illustrating an example 600 of an SBFD slot format, in accordance with the present disclosure.

In some examples, a UE 120 may be configured with a TDD slot pattern, which may semi-statically schedule certain slots and/or symbols as downlink slots and/or symbols (e.g., to be used for downlink communications), certain slots and/or symbols as uplink slots and/or symbols (e.g., to be used for uplink communications), and/or certain slots and/or symbols as flexible slots and/or symbols (e.g., to be dynamically scheduled and/or used for either downlink communications or uplink communications). In some aspects, a UE 120 may be configured with a TDD slot pattern via an RRC TDD configuration parameter, such as one of a common TDD configuration parameter (sometimes referred to as tdd-UL-DL-ConfigurationCommon) or a dedicated TDD configuration parameter (sometimes referred to as tdd-UL-DL-ConfigurationDedicated). A slot which is configured as a downlink slot may referred to as a “D” slot, a slot which is configured as an uplink slot may referred to as a “U” slot, and a slot which is configured as a flexible slot may referred to as an “F” slot. Moreover, in examples in which a network node may be operating in an SBFD mode, such as by using the UL sub-bands and DL sub-bands shown in example 510 of FIG. 5, a slot in which the simultaneous transmissions occur may be referred to as an SBFD slot, or simply a “D+U” slot. A D+U slot may contain downlink-only symbols, uplink-only symbols, and FD symbols (e.g., symbols in which simultaneous transmissions in the uplink and downlink may occur). In some examples, a D+U slot may be associated with a D slot configured by a common TDD configuration parameter (e.g., tdd-UL-DL-ConfigurationCommon) or a dedicated TDD configuration parameter (e.g., tdd-UL-DL-ConfigurationDedicated), with certain symbols thereof scheduled for SBFD communications (e.g., containing both UL sub-bands and DL sub-bands).

More particularly, the example 600 shows an example D+U slot format including downlink-only symbols 602, a first set of FD symbols 604, a second set of FD symbols 606, and uplink-only symbols 608. In some examples, the downlink-only symbols 602 may be associated with a downlink band 610 used by a network node 110 (e.g., network node 404) to transmit downlink communications to a UE 120 (e.g., UE 402), such as downlink control information (shown as “DL CTL”) and/or downlink data (shown as “DL Data”). For example, the downlink-only symbols 602 may be used by a network node 110 to transmit downlink control information and/or downlink data to a first UE 120, shown as “UE1” in FIG. 6. Similarly, the uplink-only symbols 608 may be associated with an uplink band 612 used by the first UE 120 to transmit uplink communications to the network node 110, such as uplink data (e.g., using a physical uplink shared channel (PUSCH)) and/or additional uplink information (shown simply as “UL” in FIG. 6).

The FD symbols 604 and 606 may be symbols in which the frequency band is used for both uplink and downlink transmissions. As described above in connection with FIG. 5, the uplink and downlink transmissions may occur in overlapping bands (e.g., for IBFD operation) or adjacent bands (e.g., for SBFD operation, as shown in FIG. 6). More particularly, the FD symbols 604 may include a first downlink sub-band 614 used by the network node 110 to transmit downlink communications, such as downlink control information and/or downlink data to the first UE 120, as well as a second downlink sub-band 616 used by the network node 110 to transmit downlink communications, such as downlink control information and/or downlink data to a second UE 120 (e.g., UE 402, shown as “UE2” in FIG. 6). Moreover, the FD symbols 604 may include an uplink sub-band 618 used by one of the first or second UEs 120 (e.g., the first UE 120 in the example shown in FIG. 6) to transmit uplink communications to the network node, such as uplink data in a PUSCH or other uplink information. Similarly, the FD symbols 606 may include a first downlink sub-band 620 and a second downlink sub-band 622 (which may be substantially similar to the first downlink sub-band 614 and the second downlink sub-band 616), as well as an uplink sub-band 624 (which may be substantially similar to the uplink sub-band 618). The SBFD slot structure shown in FIG. 6 may include additional symbols and/or bands, such as symbols used as sounding reference signal (SRS) resources 626 (e.g., resources used by the first and/or second UE 120 to transmit SRSs to the network node 110) and/or guard symbols and/or bands separating downlink and uplink transmissions and/or sub-bands (shown using cross-hatching in FIG. 6).

In this way, in a given D+U symbol, an HD UE 120 (e.g., UE1 402-1 and/or UE2 402-2 of example 410 of FIG. 4B) either transmits in an uplink band (e.g., uplink band 612, uplink sub-band 618, or uplink sub-band 624) or receives in a downlink band (e.g., downlink band 610, downlink sub-band 614, downlink sub-band 616, downlink sub-band 620, or downlink sub-band 622). However, an FD UE 120 (e.g., UE1 402 of example 400 of FIG. 4A and/or UE1 402 of example 420 of FIG. 4C) may transmit in an uplink band (e.g., uplink sub-band 618 and/or uplink sub-band 624) and/or receive in a downlink band (e.g., downlink sub-band 614, downlink sub-band 616, downlink sub-band 620, and/or downlink sub-band 622) in the same symbol. For example, in the example shown in FIG. 6, the first UE 120 (e.g., UE1) may simultaneously transmit communications in the uplink sub-band 618 and receive communications in the downlink sub-band 614, and/or may simultaneously transmit communications in the uplink sub-band 624 and receive communications in the downlink sub-band 620.

In some examples, a UE 120 may receive an SBFD configuration (e.g., a configuration associated with the downlink and uplink sub-bands in the 1-D symbols 604, 606 shown in FIG. 6) as well as a BWP configuration (e.g., a configuration associated with an uplink BWP and/or a downlink BWP). Moreover, in some cases, a BWP configuration may be associated with an absolute frequency location of a common resource block (CRB) (e.g., a CRB indexed as CRB0), sometimes referred to as “Point A.” For example, the BWP configuration may include certain parameters associated with a frequency domain location of the BWP, such as a location and bandwidth parameter (sometimes referred to as locationAndBandwidth), indicating a frequency domain location and bandwidth of the BWP; a subcarrier spacing (SCS) parameters (sometimes referred to as subcarrierSpacing), indicating an SCS to be used for the BWP for all channels and reference signals unless explicitly configured elsewhere; an absolute frequency position parameter (sometimes referred to as absoluteFrequencyPointA), indicating an absolute frequency position of the reference resource block (CRB0); a SCS carrier parameter (sometimes referred to as scs-SpecificCarrierList), indicating a set of carriers for different SCSs (e.g., different numerologies); a frequency position offset parameter (sometimes referred to as offsetToPointA), indicating a frequency offset between Point A and a synchronization signal/physical broadcast channel (SS/PBCH block) in a primary cell (PCell); and/or a common SCS parameter (sometimes referred to as subCarrierSpacingCommon), indicating an SCS associated with a system information block and/or initial access messages.

In some examples, such as for BWPs associated with a PCell, Point A may be obtained by a UE 120 by using the frequency position offset parameter (e.g., offsetToPointA) and the common SCS parameter (e.g., subCarrierSpacingCommon). More particularly, the frequency position offset parameter (e.g., offsetToPointA) may represent the frequency offset between Point A and the lowest subcarrier of the lowest resource block with overlaps with the SS/PBCH used by the UE 120 for initial cell selection, expressed in units of resource blocks assuming 15 kilohertz (kHz) SCS for FR1 and 60 kHz SCS for FR2. In some cases, such as for operation with shared spectrum channel access in FR1 and FR2-1, the lowest resource block may have the SCS provided by the common SCS parameter (e.g., subCarrierSpacingCommon). In some other cases, such as for operation with shared spectrum channel access in FR1 or FRA, and for operations without shared spectrum channel access in FR2-2, the lowest resource block may have the SCS same as the SS/PBCH block used by the UE 120 for initial cell selection. In some other examples, such as for BWPs associated with a secondary cell (SCell), Point A may be obtained from the absolute frequency position parameter (e.g., absoluteFrequencyPointA).

In some examples, a BWP may be associated with a number of physical resource blocks (PRB), which may be defined based at least in part on CRB0 (e.g., the location of Point A). More particularly, CRBs may be numbered from 0 upwards in the frequency domain for a given SCS configuration (e.g., for a given numerology, sometimes referred to as p). The center of subcarrier 0 of CRB0 for SCS configuration p may coincide with Point A. The relation between the CRB number n_{CRB}^{μ} in the frequency domain and resource elements (k, l) for SCS configuration μ may be given by

$${n}_{CRB}^{μ} = ⌊ \frac{k}{{N}_{sc}^{RB}} ⌋ ,$$

where k is defined relative to Point A such that k=0 corresponding to the subcarrier centered around point A, and where NR B corresponds to the number of subcarriers per resource block. Moreover, PRBs for a SCS configuration p may be defined within a BWP and may be numbered from 0 to N_{BWP,i}^{size,μ}−1, where i is the number of the BWP. The relation between the PRB n_{PRB}^{μ} in BWP i and the CRB n_{CRB}^{μ} may be given by n_{CRB}^{μ}=n_{PRB}^{μ}+N_{Bwp,i}^{start,μ}, where n_{BWP,i}^{start,μ} is the CRB where BWP i starts relative to CRB0.

In such examples, a frequency location of a BWP may be well defined with respect to Point A, the SCS, and other parameters. However, a frequency location of one or more sub-bands, such as one of the uplink sub-band 618, the uplink sub-band 624, the downlink sub-band 614, the downlink sub-band 616, the downlink sub-band 620, and/or the downlink sub-band 622, may not be well defined. Moreover, an SBFD sub-band configuration may be cell-specific, and thus may vary from cell to cell. Accordingly, a UE 120 or other wireless communication device may not be aware of frequency locations of SBFD sub-bands and/or may misinterpret SBFD sub-band configurations, thereby resulting in increased communication errors and thus power, computing, and network resource consumption to correct communication errors, as well as increased overhead associated with retransmissions and other corrective communications, leading to increased latency, decreased throughput, and overall inefficient usage of network resources.

Some techniques and apparatuses described herein enable procedures and signaling for configuring uplink sub-bands and/or downlink sub-bands in D+U slots. In some aspects, a UE 120 may be configured, preconfigured, or hard-coded with a relationship between a sub-band and a BWP, a common reference point (e.g., Point A), a minimum overlap, an SCS, and/or similar parameters, such that the UE 120 may identify at least one of frequency resources associated with transmitting an uplink communication or frequency resources associated with receiving a downlink communication based at least in part on a BWP configuration and an SBFD configuration. As a result, a UE 120 or other wireless communication device may be aware be aware of frequency locations of SBFD sub-bands and/or may readily identify frequency resources associated with various uplink and downlink communications, thereby reducing communication errors and thus conserving power, computing, and network resources that would otherwise be used to correct communication errors, as well as decreasing overhead associated with retransmissions and other corrective communications, resulting in decreased latency, increased throughput, and overall more efficient usage of network resources.

As indicated above, FIG. 6 is provided as an example. Other examples may differ from what is described with respect to FIG. 6.

FIG. 7 is a diagram of an example 700 associated with configuring sub-band full duplex resources, in accordance with the present disclosure. As shown in FIG. 7, a network node 110 (e.g., a CU, a DU, and/or an RU) may communicate with a UE 120. In some aspects, the network node 110 and the UE 120 may be part of a wireless network (e.g., wireless network 100). The UE 120 and the network node 110 may have established a wireless connection prior to operations shown in FIG. 7. In some aspects, at least one of the network node 110 or the UE 120 may be capable of operating in an FD mode, such as one of the FD modes described in connection with FIGS. 4-6. For example, in some aspects the UE 120 and/or the network node 110 may be capable of operating in an SBFD mode.

As shown by reference number 705, the network node 110 may transmit, and the UE 120 may receive, configuration information. In some aspects, the UE 120 may receive the configuration information via one or more of RRC signaling, one or more MAC control elements (MAC-CEs), and/or downlink control information (DCI), among other examples. In some aspects, the configuration information may include an indication of one or more configuration parameters (e.g., already known to the UE 120 and/or previously indicated by the network node 110 or other network device) for selection by the UE 120, and/or explicit configuration information for the UE 120 to use to configure the UE 120, among other examples.

In some aspects, the configuration information may indicate a BWP configuration and/or an SBFD configuration. More particularly, the network node 110 may transmit, and the UE 120 may receive, a first configuration of at least one of an uplink BWP or a downlink BWP, and a second configuration of at least one of an uplink sub-band or a downlink sub-band. In some aspects, the at least one of the uplink sub-band or the downlink sub-band may be associated with an SBFD symbol (e.g., a symbol associated with FD symbols 604, 606), while, in some other aspects, the at least one of the uplink sub-band or the downlink sub-band may be associated with a symbol associated with a different FD operation (e.g., an IBFD symbol or a similar symbol). In some aspects, the UE 120 may be configured with multiple uplink BWPs and/or multiple downlink BWPs, and/or the configuration of the at least one of the uplink sub-band or the downlink sub-band being may be cell-specific, as described above in connection with FIG. 6.

In some aspects, the UE 120 may be configured, pre-configured, and/or specified (e.g., hard coded) with a relation between a location of uplink sub-bands with respect to a location of uplink BWPs, and/or a location of the downlink sub-bands with respect to a location of downlink BWPs. For example, the UE 120 may be configured, pre-configured, and/or specified with information as to whether a BWP fully contains a respective sub-band, whether a BWP at least partially overlaps with a respective sub-band, or similar information. For example, in some aspects, an uplink BWP may be configured to fully contain uplink sub-bands in SBFD symbols. In such aspects, the first configuration may include a configuration of the uplink BWP, the second configuration may include a configuration of the uplink sub-band, and frequency resources associated with the uplink BWP may contain frequency resources associated with the uplink sub-band.

In some other aspects, an uplink sub-band may not fully contain an uplink sub-band, but instead an uplink BWP may be configured to at least partially overlap with the uplink sub-band. In such aspects, the first configuration may include a configuration of the uplink BWP, the second configuration may include a configuration of the uplink sub-band, and frequency resources associated with the uplink BWP may at least partially overlap with frequency resources associated with the uplink sub-band. Moreover, the frequency resources associated with the uplink BWP may at least partially overlap with the frequency resources associated with the uplink sub-band by at least a minimum overlap amount, such as for purposes of guaranteeing an availability of minimum uplink resources to be used for uplink transmissions (which is described in more detail below in connection with reference number 730). Additionally, or alternatively, in aspects in which the uplink BWP and the uplink sub-band only partially overlap, the UE 120 may transmit uplink communications using the overlapping resources, and/or the UE 120 may retune the uplink BWP in order to align the uplink BWP with the uplink sub-band, which is described in more detail below in connection with reference number 730.

In some other aspects, an uplink BWP may not overlap with the uplink sub-band. More particularly, in some aspects, the first configuration may include a configuration of the uplink BWP, the second configuration may include a configuration of the uplink sub-band, and frequency resources associated with the uplink BWP may not overlap with frequency resources associated with the uplink sub-band. In such aspects, the UE 120 may transmit uplink communications outside of the uplink sub-band, the UE 120 may refrain transmitting uplink communications because there are no overlapping resources between the uplink sub-band and the uplink BWP, and/or the UE 120 may retune the uplink BWP in order to align the uplink BWP with the uplink sub-band, which are described in more detail below in connection with reference number 730.

Similarly, in some aspects, the UE 120 may be configured, pre-configured, and/or specified (e.g., hard coded) with a relation between a location of downlink sub-bands with respect to a location of downlink BWPs. For example, in some aspects, a downlink BWP may be configured to fully contain downlink sub-bands in SBFD symbols. Put another way, in some aspects, the first configuration may include a configuration of the downlink BWP, the second configuration may include a configuration of the downlink sub-band, and frequency resources associated with the downlink BWP may contain frequency resources associated with the downlink sub-band.

In some other aspects, the downlink BWP may be configured to at least partially overlap with at least one downlink sub-band. More particularly, the first configuration may include a configuration of the downlink BWP, the second configuration may include a configuration of the downlink sub-band, and frequency resources associated with the downlink BWP may at least partially overlap with frequency resources associated with the downlink sub-band. In such aspects, the frequency resources associated with the downlink BWP may at least partially overlap with the frequency resources associated with the downlink sub-band by at least a minimum overlap amount. Additionally, or alternatively, in aspects in which the downlink BWP partially overlaps with the downlink sub-band, the UE 120 may receive downlink communications using the overlapping resources and may not be receive downlink communications outside of the overlapping resources, which is described in more detail below in connection with reference number 735.

In some other aspects, the downlink BWP may not overlap with the downlink sub-band. More particularly, the first configuration may include a configuration of the downlink BWP, the second configuration may include a configuration of the downlink sub-band, and frequency resources associated with the downlink BWP may not overlap with frequency resources associated with the downlink sub-band. In such aspects, the UE 120 may receive downlink communications outside of the uplink sub-band, or the UE 120 may refrain from receiving downlink communications because there are no overlapping resources between the downlink sub-band and the downlink BWP, which are described in more detail below in connection with reference number 735.

In some aspects, the UE 120 may be configured, pre-configured, and/or specified (e.g., hard coded) with a relation between a location of uplink and/or downlink sub-bands with respect to a common reference point (e.g., Point A). Additionally, or alternatively, the UE 120 may be configured, pre-configured, and/or specified with certain parameters to be used to determine a location of uplink and/or downlink sub-bands, such as a specific SCS that should be used to determine the location of the uplink sub-band and/or the downlink sub-band with respect to the common reference point, an offset of the uplink sub-band and/or the downlink sub-band from a common reference point, or similar parameters. Put another way, in some aspects, the second configuration (e.g., the configuration of the at least one of the uplink sub-band or the downlink sub-band) may be based at least in part on a specific SCS, and/or the second configuration may be based at least in part on an offset from an absolute frequency position (e.g., Point A) of a reference resource block (e.g., CRB0).

In some aspects, the specific SCS may be based at least in part on a frequency band associated with the at least one of the uplink BWP or the downlink BWP. That is, the specific SCS may be a fixed SCS based at least in part on a frequency band associated with a corresponding BWP, such as a fixed SCS of 15 kHz for FR1, a fixed SCS of 60 kHz for FR2, or a similar fixed SCS.

In some other aspects, the specific SCS may be configurable. In such aspects, the network node 110 may transmit, and the UE 120 may receive, a configuration of the specific SCS. For example, the network node 110 may transmit the configuration of the specific SCS via a master information block (MIB). More particularly, the configuration of the specific SCS may be based at least in part on a common subcarrier spacing parameter (e.g., subcarrierSpacingCommon) associated with the MIB.

Additionally, or alternatively, the second configuration (e.g., the configuration of the at least one of the uplink sub-band or the downlink sub-band) may be based at least in part on an offset parameter associated with an SCS associated with the at least one of the uplink BWP or the downlink BWP. For example, a location of an uplink sub-band and/or a downlink sub-band may be based at least in part on a list of offsets associated with various SCSs that are relative to a common reference point (e.g., Point A and/or CRB0). For example, the UE 120 may be configured, preconfigured, and/or specified (e.g., hard-coded) with a list of offsets relative to CRB0, with each offset corresponding to an SCS value. In that regard, the list of offsets relative to CRB0 may include a first offset (sometimes referred to as offset-0) to be used for an SCS of 15 kHz, a second offset (sometimes referred to as offset-1) to be use for an SCS of 60 kHz, and so forth.

In some aspects, a specific SCS used to determine a location of an uplink sub-band and/or a downlink sub-band may be different than an SCS associated with an uplink BWP and/or a downlink BWP. In such aspects, using the specific SCS to determine the location of the uplink sub-band and/or the downlink sub-band may result partial overlap between an edge PRB associated with the sub-band (e.g., a PRB associated with a start of the uplink sub-band and/or downlink sub-band) and an adjacent edge PRB associated with the BWP (e.g., a PRB of the corresponding BWP that at least partially overlaps with the PRB associated with a start of the uplink sub-band and/or downlink sub-band). In such aspects, the UE 120 may ignore the edge PRBs associated with the BWP that partially overlap with the uplink sub-band and/or downlink sub-band, and instead treat the start of uplink resources and/or downlink resources as corresponding to a first PRB in the corresponding BWP that is completely contained in the corresponding uplink sub-band or the downlink sub-band. Put another way, in some aspects, the specific SCS may be different than an SCS associated with the at least one of the uplink BWP or the downlink BWP, resulting in an edge PRB associated with the at least one of the uplink BWP or the downlink BWP only partially overlapping with the at least one of the uplink sub-band or the downlink sub-band, and thus frequency resources associated with the edge PRB may not be used for communication based at least in part on the edge PRB only partially overlapping with the at least one of the at least one of the uplink sub-band or the downlink sub-band.

In some aspects, the UE 120 may be configured with at least a minimum number of uplink resources and/or at least a minimum number of downlink resources in a set of SBFD symbols, such as for purposes of guaranteeing a sufficient number of resources for transmitting or receiving a communication. Accordingly, in some aspects, the at least one of the uplink sub-band or the downlink sub-band may be associated with at least a minimum number of frequency resources. For example, an uplink sub-band, and/or a minimum overlap between an uplink sub-band and an uplink BWP, may be associated with at least four resource blocks, such as for purposes of guaranteeing enough frequency resources for transmitting an SRS (which may span four resource blocks). Additionally, or alternatively, a downlink sub-band, and/or a minimum overlap between a downlink sub-band and a downlink BWP, may be associated with at least enough resource blocks to transmit at least one of a tracking reference signal (TRS), a channel state information reference signal (CSI-RS), or similar reference signal. Moreover, in aspects in which a set of symbols includes multiple downlink sub-bands, such as described above in connection with FD symbols 604 and 606, the UE 120 may be configured with at least a minimum number of total downlink resource blocks associated with the multiple downlink resources. Put another way, in some aspects, the second configuration (e.g., the configuration of at least one of an uplink sub-band or a downlink sub-band) may include a configuration of multiple downlink sub-bands, and the multiple downlink sub-bands may be associated with at least a minimum number of downlink resource blocks.

The UE 120 may configure itself based at least in part on the configuration information. In some aspects, the UE 120 may be configured to perform one or more operations described herein based at least in part on the configuration information.

Based at least in part on the first configuration (e.g., the configuration of the at least one of the uplink BWP or the downlink BWP) and the second configuration (e.g., the configuration of the at least one of the uplink sub-band or the downlink sub-band), the UE 120 and/or the network node 110 may identify uplink (UL) resources 720 and/or downlink (DL) resources 725 to be used for communicating in a set of symbols (e.g., an SBFD set of symbols). More particularly, as shown by reference number 710, the UE 120 may identify at least one of frequency resources associated with transmitting an uplink communication (e.g., UL resources 720) or frequency resources associated with receiving a downlink communication (e.g., DL resources 725) based at least in part on the first configuration and the second configuration. Similarly, as shown by reference number 715, the network node 110 may identify at least one of frequency resources associated with receiving an uplink communication (e.g., UL resources 720) or frequency resources associated with transmitting a downlink communication (e.g., DL resources 725) based at least in part on the first configuration and the second configuration.

As shown by reference number 730, the UE 120 may transmit, and the network node 110 may receive, an uplink communication using the UL resources 720. In some aspects, the UE 120 may not be expected to transmit uplink signals outside of an intersection of an uplink sub-band and an uplink BWP. Put another way, any uplink transmissions scheduled outside of an overlap between an uplink sub-band and an uplink BWP may be dropped by the UE 120. Thus, in such aspects, the UE 120 may transmit, and the network node 110 may receive, the uplink communication using a subset of the frequency resources associated with the uplink sub-band that overlap with the frequency resources associated with the uplink BWP, and/or the UE 120 may refrain from transmitting an uplink communication based at least in part on the uplink communication being scheduled outside of the subset of the frequency resources associated with the uplink sub-band that overlap with the frequency resources associated with the uplink BWP.

In some aspects, if an uplink sub-band does not overlap with an uplink BWP, the UE 120 may retune the uplink BWP in order to contain the uplink sub-band, and then the UE 120 may transmit the uplink communication using the frequency resources associated with the uplink sub-band. In such aspects, the UE 120 may adjust the uplink BWP such that the frequency resources associated with the uplink BWP contain the frequency resources associated with the uplink sub-band. Additionally, or alternatively, if an uplink sub-band does not overlap with an uplink BWP, the UE 120 may either refrain from receiving an uplink communication and/or may receive the uplink communication outside of the uplink sub-band. More particularly, in some aspects, the UE 120 may refrain from transmitting the uplink communication based at least in part on the frequency resources associated with the uplink BWP not overlapping with the frequency resources associated with the uplink sub-band, and, in some other aspects, the UE 120 may transmit the uplink communication outside of the uplink sub-band based at least in part on the frequency resources associated with the uplink BWP not overlapping with the frequency resources associated with the uplink sub-band.

As shown by reference number 735, in some aspects, the network node 110 may transmit, and the UE 120 may receive, a downlink communication using the DL resources 725. In some aspects, the UE 120 may not be expected to receive downlink signals outside of an intersection of a downlink sub-band and a downlink BWP. Put another way, any downlink transmissions scheduled outside of an overlap between a downlink sub-band and a downlink BWP may not be received by the UE 120. Thus, in such aspects, the network node 110 may transmit, and the UE 120 may receive, a downlink communication using a subset of the frequency resources associated with the downlink sub-band that overlap with the frequency resources associated with the downlink BWP, and/or the UE 120 may refrain from receiving a downlink communication based at least in part on the downlink communication being scheduled outside of the subset of the frequency resources associated with the downlink sub-band that overlap with the frequency resources associated with the downlink BWP.

In some aspects, if a downlink sub-band does not overlap with a downlink BWP, the UE 120 may either refrain from receiving a downlink communication and/or may receive the downlink communication outside of the downlink sub-band. More particularly, in some aspects, the UE 120 may refrain from receiving the downlink communication based at least in part on the frequency resources associated with the downlink BWP not overlapping with the frequency resources associated with the downlink sub-band, and, in some other aspects, the UE 120 may receive the downlink communication outside of the downlink sub-band based at least in part on the frequency resources associated with the downlink BWP not overlapping with the frequency resources associated with the downlink sub-band.

Based at least in part on the UE 120 and/or the network node 110 communicating using the procedures and signaling for configuring uplink sub-bands and/or downlink sub-bands described above in connection with reference numbers 705-735, the UE 120 and/or the network node 110 may conserve computing, power, network, and/or communication resources that may have otherwise been consumed traditional SBFD communication or similar FD operations. For example, based at least in part on the UE 120 and/or the network node 110 communicating using the procedures and signaling for configuring uplink sub-bands and/or downlink sub-bands described above in connection with reference numbers 705-735, the UE 120 and the network node 110 may communicate with a reduced error rate, which may conserve computing, power, network, and/or communication resources that may have otherwise been consumed to detect and/or correct communication errors.

As indicated above, FIG. 7 is provided as an example. Other examples may differ from what is described with respect to FIG. 7.

FIG. 8 is a diagram illustrating an example process 800 performed, for example, by a UE, in accordance with the present disclosure. Example process 800 is an example where the UE (e.g., UE 120) performs operations associated with techniques for configuring sub-band full duplex resources.

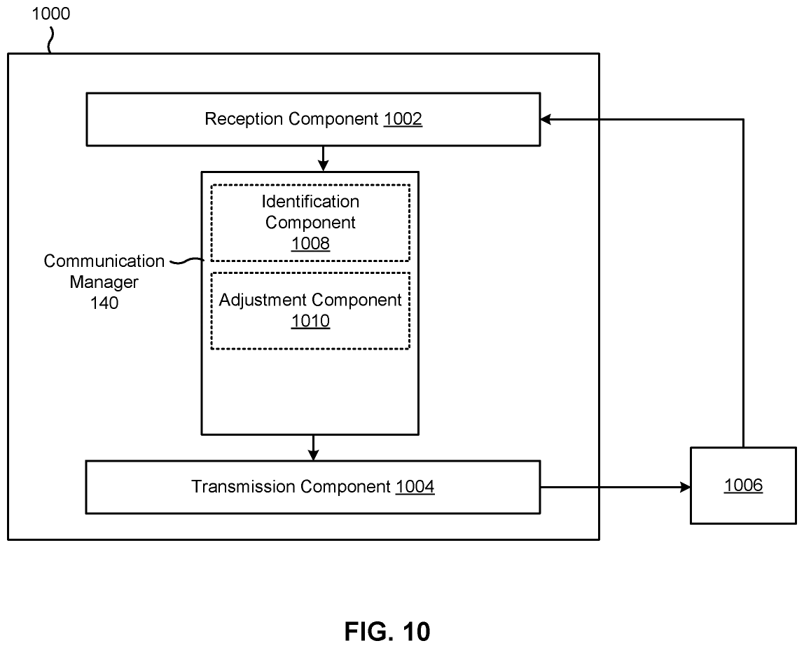

As shown in FIG. 8, in some aspects, process 800 may include receiving a first configuration of at least one of an uplink BWP or a downlink BWP (block 810). For example, the UE (e.g., using communication manager 140 and/or reception component 1002, depicted in FIG. 10) may receive a first configuration of at least one of an uplink BWP or a downlink BWP, as described above.

As further shown in FIG. 8, in some aspects, process 800 may include receiving a second configuration of at least one of an uplink sub-band or a downlink sub-band (block 820). For example, the UE (e.g., using communication manager 140 and/or reception component 1002, depicted in FIG. 10) may receive a second configuration of at least one of an uplink sub-band or a downlink sub-band, as described above.

As further shown in FIG. 8, in some aspects, process 800 may include identifying at least one of frequency resources associated with transmitting an uplink communication or frequency resources associated with receiving a downlink communication based at least in part on the first configuration and the second configuration (block 830). For example, the UE (e.g., using communication manager 140 and/or identification component 1008, depicted in FIG. 10) may identify at least one of frequency resources associated with transmitting an uplink communication or frequency resources associated with receiving a downlink communication based at least in part on the first configuration and the second configuration, as described above.

Process 800 may include additional aspects, such as any single aspect or any combination of aspects described below and/or in connection with one or more other processes described elsewhere herein.

In a first aspect, the at least one of the uplink sub-band or the downlink sub-band is associated with a sub-band full duplex symbol.

In a second aspect, alone or in combination with the first aspect, the first configuration includes a configuration of the uplink BWP, the second configuration includes a configuration of the uplink sub-band, and frequency resources associated with the uplink BWP contain frequency resources associated with the uplink sub-band.

In a third aspect, alone or in combination with one or more of the first and second aspects, the first configuration includes a configuration of the uplink BWP, the second configuration includes a configuration of the uplink sub-band, and frequency resources associated with the uplink BWP at least partially overlap with frequency resources associated with the uplink sub-band.

In a fourth aspect, alone or in combination with one or more of the first through third aspects, the frequency resources associated with the uplink BWP at least partially overlap with the frequency resources associated with the uplink sub-band by at least a minimum overlap amount.

In a fifth aspect, alone or in combination with one or more of the first through fourth aspects, process 800 includes transmitting the uplink communication using a subset of the frequency resources associated with the uplink sub-band that overlap with the frequency resources associated with the uplink BWP.

In a sixth aspect, alone or in combination with one or more of the first through fifth aspects, process 800 includes refraining from transmitting the uplink communication based at least in part on the uplink communication being scheduled outside of a subset of the frequency resources associated with the uplink sub-band that overlap with the frequency resources associated with the uplink BWP.

In a seventh aspect, alone or in combination with one or more of the first through sixth aspects, process 800 includes adjusting the uplink BWP such that the frequency resources associated with the uplink BWP contain the frequency resources associated with the uplink sub-band.

In an eighth aspect, alone or in combination with one or more of the first through seventh aspects, the first configuration includes a configuration of the uplink BWP, the second configuration includes a configuration of the uplink sub-band, and frequency resources associated with the uplink BWP do not overlap with frequency resources associated with the uplink sub-band.

In a ninth aspect, alone or in combination with one or more of the first through eighth aspects, process 800 includes refraining from transmitting the uplink communication based at least in part on the frequency resources associated with the uplink BWP not overlapping with the frequency resources associated with the uplink sub-band.

In a tenth aspect, alone or in combination with one or more of the first through ninth aspects, process 800 includes adjusting the uplink BWP such that the frequency resources associated with the uplink BWP contain the frequency resources associated with the uplink sub-band.

In an eleventh aspect, alone or in combination with one or more of the first through tenth aspects, the first configuration includes a configuration of the downlink BWP, the second configuration includes a configuration of the downlink sub-band, and frequency resources associated with the downlink BWP contain frequency resources associated with the downlink sub-band.

In a twelfth aspect, alone or in combination with one or more of the first through eleventh aspects, the first configuration includes a configuration of the downlink BWP, the second configuration includes a configuration of the downlink sub-band, and frequency resources associated with the downlink BWP at least partially overlap with frequency resources associated with the downlink sub-band.

In a thirteenth aspect, alone or in combination with one or more of the first through twelfth aspects, the frequency resources associated with the downlink BWP at least partially overlap with the frequency resources associated with the downlink sub-band by at least a minimum overlap amount.

In a fourteenth aspect, alone or in combination with one or more of the first through thirteenth aspects, process 800 includes receiving the downlink communication using a subset of the frequency resources associated with the downlink sub-band that overlap with the frequency resources associated with the downlink BWP.

In a fifteenth aspect, alone or in combination with one or more of the first through fourteenth aspects, process 800 includes refraining from receiving the downlink communication based at least in part on the downlink communication being scheduled outside of a subset of the frequency resources associated with the downlink sub-band that overlap with the frequency resources associated with the downlink BWP.

In a sixteenth aspect, alone or in combination with one or more of the first through fifteenth aspects, the first configuration includes a configuration of the downlink BWP, the second configuration includes a configuration of the downlink sub-band, and frequency resources associated with the downlink BWP do not overlap with frequency resources associated with the downlink sub-band.

In a seventeenth aspect, alone or in combination with one or more of the first through sixteenth aspects, process 800 includes refraining from receiving the downlink communication based at least in part on the frequency resources associated with the downlink BWP not overlapping with the frequency resources associated with the downlink sub-band.

In an eighteenth aspect, alone or in combination with one or more of the first through seventeenth aspects, the second configuration is based at least in part on a specific subcarrier spacing.

In a nineteenth aspect, alone or in combination with one or more of the first through eighteenth aspects, the second configuration is further based at least in part on an offset from an absolute frequency position of a reference resource block.

In a twentieth aspect, alone or in combination with one or more of the first through nineteenth aspects, the specific subcarrier spacing is based at least in part on a frequency band associated with the at least one of the uplink BWP or the downlink BWP.

In a twenty-first aspect, alone or in combination with one or more of the first through twentieth aspects, process 800 includes receiving a configuration of the specific subcarrier spacing.

In a twenty-second aspect, alone or in combination with one or more of the first through twenty-first aspects, the configuration of the specific subcarrier spacing is based at least in part on a common subcarrier spacing parameter associated with a master information block.

In a twenty-third aspect, alone or in combination with one or more of the first through twenty-second aspects, the specific subcarrier spacing is different than a subcarrier spacing associated with the at least one of the uplink BWP or the downlink BWP, a PRB associated with the at least one of the uplink BWP or the downlink BWP only partially overlaps with the at least one of the uplink sub-band or the downlink sub-band based at least in part on the specific subcarrier spacing being different than the subcarrier spacing associated with the at least one of the uplink BWP or the downlink BWP, and frequency resources associated with the PRB are not used for communication based at least in part on the PRB only partially overlapping with the at least one of the at least one of the uplink sub-band or the downlink sub-band.

In a twenty-fourth aspect, alone or in combination with one or more of the first through twenty-third aspects, the second configuration is based at least in part on an offset parameter associated with a subcarrier spacing associated with the at least one of the uplink BWP or the downlink BWP.

In a twenty-fifth aspect, alone or in combination with one or more of the first through twenty-fourth aspects, the at least one of the uplink sub-band or the downlink sub-band is associated with at least a minimum number of frequency resources.

In a twenty-sixth aspect, alone or in combination with one or more of the first through twenty-fifth aspects, process 800 includes receiving a configuration of the downlink BWP, and receiving a configuration of multiple downlink sub-bands, wherein the multiple downlink sub-bands are associated with at least a minimum number of downlink resource blocks.

In a twenty-seventh aspect, alone or in combination with one or more of the first through twenty-sixth aspects, process 800 includes performing at least one of transmitting the uplink communication outside of the uplink sub-band or receiving the downlink communication outside of the downlink sub-band.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a network node, in accordance with the present disclosure. Example process 900 is an example where the network node (e.g., network node 110) performs operations associated with techniques for configuring sub-band full duplex resources.

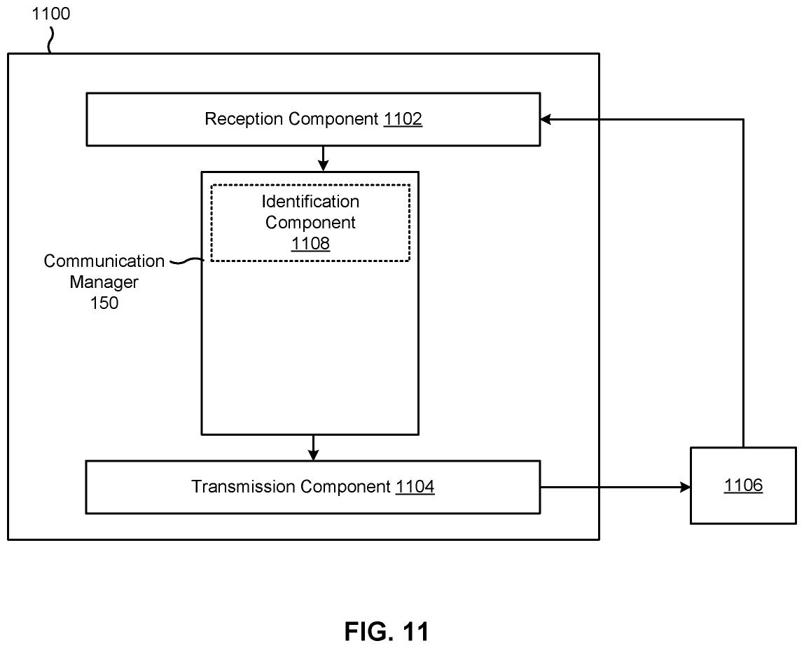

As shown in FIG. 9, in some aspects, process 900 may include transmitting a first configuration of at least one of an uplink BWP or a downlink BWP (block 910). For example, the network node (e.g., using communication manager 150 and/or transmission component 1104, depicted in FIG. 11) may transmit a first configuration of at least one of an uplink BWP or a downlink BWP, as described above.

As further shown in FIG. 9, in some aspects, process 900 may include transmitting a second configuration of at least one of an uplink sub-band or a downlink sub-band (block 920). For example, the network node (e.g., using communication manager 150 and/or transmission component 1104, depicted in FIG. 11) may transmit a second configuration of at least one of an uplink sub-band or a downlink sub-band, as described above.

As further shown in FIG. 9, in some aspects, process 900 may include identifying at least one of frequency resources associated with receiving an uplink communication or frequency resources associated with transmitting a downlink communication based at least in part on the first configuration and the second configuration (block 930). For example, the network node (e.g., using communication manager 150 and/or identification component 1108, depicted in FIG. 11) may identify at least one of frequency resources associated with receiving an uplink communication or frequency resources associated with transmitting a downlink communication based at least in part on the first configuration and the second configuration, as described above.

Process 900 may include additional aspects, such as any single aspect or any combination of aspects described below and/or in connection with one or more other processes described elsewhere herein.

In a first aspect, the at least one of the uplink sub-band or the downlink sub-band is associated with a sub-band full duplex symbol.

In a second aspect, alone or in combination with the first aspect, the first configuration includes a configuration of the uplink BWP, the second configuration includes a configuration of the uplink sub-band, and frequency resources associated with the uplink BWP contain frequency resources associated with the uplink sub-band.

In a third aspect, alone or in combination with one or more of the first and second aspects, the first configuration includes a configuration of the uplink BWP, the second configuration includes a configuration of the uplink sub-band, and frequency resources associated with the uplink BWP at least partially overlap with frequency resources associated with the uplink sub-band.

In a fourth aspect, alone or in combination with one or more of the first through third aspects, the frequency resources associated with the uplink BWP at least partially overlap with the frequency resources associated with the uplink sub-band by at least a minimum overlap amount.

In a fifth aspect, alone or in combination with one or more of the first through fourth aspects, process 900 includes receiving the uplink communication using a subset of the frequency resources associated with the uplink sub-band that overlap with the frequency resources associated with the uplink BWP.

In a sixth aspect, alone or in combination with one or more of the first through fifth aspects, the first configuration includes a configuration of the uplink BWP, the second configuration includes a configuration of the uplink sub-band, and frequency resources associated with the uplink BWP do not overlap with frequency resources associated with the uplink sub-band.

In a seventh aspect, alone or in combination with one or more of the first through sixth aspects, the first configuration includes a configuration of the downlink BWP, the second configuration includes a configuration of the downlink sub-band, and frequency resources associated with the downlink BWP contain frequency resources associated with the downlink sub-band.

In an eighth aspect, alone or in combination with one or more of the first through seventh aspects, the first configuration includes a configuration of the downlink BWP, the second configuration includes a configuration of the downlink sub-band, and frequency resources associated with the downlink BWP at least partially overlap with frequency resources associated with the downlink sub-band.

In a ninth aspect, alone or in combination with one or more of the first through eighth aspects, the frequency resources associated with the downlink BWP at least partially overlap with the frequency resources associated with the downlink sub-band by at least a minimum overlap amount.

In a tenth aspect, alone or in combination with one or more of the first through ninth aspects, process 900 includes transmitting the downlink communication using a subset of the frequency resources associated with the downlink sub-band that overlap with the frequency resources associated with the downlink BWP.

In an eleventh aspect, alone or in combination with one or more of the first through tenth aspects, the first configuration includes a configuration of the downlink BWP, the second configuration includes a configuration of the downlink sub-band, and frequency resources associated with the downlink BWP do not overlap with frequency resources associated with the downlink sub-band.

In a twelfth aspect, alone or in combination with one or more of the first through eleventh aspects, the second configuration is based at least in part on a specific subcarrier spacing.

In a thirteenth aspect, alone or in combination with one or more of the first through twelfth aspects, the second configuration is further based at least in part on an offset from an absolute frequency position of a reference resource block.

In a fourteenth aspect, alone or in combination with one or more of the first through thirteenth aspects, the specific subcarrier spacing is based at least in part on a frequency band associated with the at least one of the uplink BWP or the downlink BWP.

In a fifteenth aspect, alone or in combination with one or more of the first through fourteenth aspects, process 900 includes transmitting a configuration of the specific subcarrier spacing.

In a sixteenth aspect, alone or in combination with one or more of the first through fifteenth aspects, the configuration of the specific subcarrier spacing is based at least in part on a common subcarrier spacing parameter associated with a master information block.

In a seventeenth aspect, alone or in combination with one or more of the first through sixteenth aspects, the specific subcarrier spacing is different than a subcarrier spacing associated with the at least one of the uplink BWP or the downlink BWP, a PRB associated with the at least one of the uplink BWP or the downlink BWP only partially overlaps with the at least one of the uplink sub-band or the downlink sub-band based at least in part on the specific subcarrier spacing being different than the subcarrier spacing associated with the at least one of the uplink BWP or the downlink BWP, and frequency resources associated with the PRB are not used for communication based at least in part on the PRB only partially overlapping with the at least one of the at least one of the uplink sub-band or the downlink sub-band.

In an eighteenth aspect, alone or in combination with one or more of the first through seventeenth aspects, the second configuration is based at least in part on an offset parameter associated with a subcarrier spacing associated with the at least one of the uplink BWP or the downlink BWP.

In a nineteenth aspect, alone or in combination with one or more of the first through eighteenth aspects, the at least one of the uplink sub-band or the downlink sub-band is associated with at least a minimum number of frequency resources.

In a twentieth aspect, alone or in combination with one or more of the first through nineteenth aspects, process 900 includes transmitting a configuration of the downlink BWP, and transmitting a configuration of multiple downlink sub-bands, wherein the multiple downlink sub-bands are associated with at least a minimum number of downlink resource blocks.

In a twenty-first aspect, alone or in combination with one or more of the first through twentieth aspects, process 900 includes performing at least one of receiving the uplink communication outside of the uplink sub-band or transmitting the downlink communication outside of the downlink sub-band.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE 120, or a UE 120 may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a network node, or another wireless communication device) using the reception component 1002 and the transmission component 1004. As further shown, the apparatus 1000 may include the communication manager 140. The communication manager 140 may include one or more of an identification component 1008 or an adjustment component 1010, among other examples.

In some aspects, the apparatus 1000 may be configured to perform one or more operations described herein in connection with FIG. 7. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the UE 120 described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE 120 described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE 120 described in connection with FIG. 2. In some aspects, the transmission component 1004 may be co-located with the reception component 1002 in a transceiver.

The reception component 1002 may receive a first configuration of at least one of an uplink BWP or a downlink BWP. The reception component 1002 may receive a second configuration of at least one of an uplink sub-band or a downlink sub-band. The identification component 1008 may identify at least one of frequency resources associated with transmitting an uplink communication or frequency resources associated with receiving a downlink communication based at least in part on the first configuration and the second configuration.

The transmission component 1004 may transmit the uplink communication using a subset of the frequency resources associated with the uplink sub-band that overlap with the frequency resources associated with the uplink BWP.

The identification component 1008 may cause the UE 120 to refrain from transmitting the uplink communication based at least in part on the uplink communication being scheduled outside of a subset of the frequency resources associated with the uplink sub-band that overlap with the frequency resources associated with the uplink BWP.

The adjustment component 1010 may adjust the uplink BWP such that the frequency resources associated with the uplink BWP contain the frequency resources associated with the uplink sub-band.

The identification component 1008 may cause the UE 120 to refrain from transmitting the uplink communication based at least in part on the frequency resources associated with the uplink BWP not overlapping with the frequency resources associated with the uplink sub-band.

The adjustment component 1010 may adjust the uplink BWP such that the frequency resources associated with the uplink BWP contain the frequency resources associated with the uplink sub-band.

The reception component 1002 may receive the downlink communication using a subset of the frequency resources associated with the downlink sub-band that overlap with the frequency resources associated with the downlink BWP.

The identification component 1008 may cause the UE 120 to refrain from receiving the downlink communication based at least in part on the downlink communication being scheduled outside of a subset of the frequency resources associated with the downlink sub-band that overlap with the frequency resources associated with the downlink BWP.

The identification component 1008 may cause the UE 120 to refrain from receiving the downlink communication based at least in part on the frequency resources associated with the downlink BWP not overlapping with the frequency resources associated with the downlink sub-band.

The reception component 1002 may receive a configuration of the specific subcarrier spacing.

The reception component 1002 may receive a configuration of the downlink BWP.

The reception component 1002 may receive a configuration of multiple downlink sub-bands, wherein the multiple downlink sub-bands are associated with at least a minimum number of downlink resource blocks.

The transmission component 1004 and/or the reception component 1002 may perform at least one of transmitting the uplink communication outside of the uplink sub-band or receiving the downlink communication outside of the downlink sub-band.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a network node 110, or a network node 110 may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a network node, or another wireless communication device) using the reception component 1102 and the transmission component 1104. As further shown, the apparatus 1100 may include the communication manager 150. The communication manager 150 may include an identification component 1108, among other examples.

In some aspects, the apparatus 1100 may be configured to perform one or more operations described herein in connection with FIG. 7. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the network node 110 described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the network node 110 described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the network node 110 described in connection with FIG. 2. In some aspects, the transmission component 1104 may be co-located with the reception component 1102 in a transceiver.

The transmission component 1104 may transmit a first configuration of at least one of an uplink BWP or a downlink BWP. The transmission component 1104 may transmit a second configuration of at least one of an uplink sub-band or a downlink sub-band. The identification component 1108 may identify at least one of frequency resources associated with receiving an uplink communication or frequency resources associated with transmitting a downlink communication based at least in part on the first configuration and the second configuration.

The reception component 1102 may receive the uplink communication using a subset of the frequency resources associated with the uplink sub-band that overlap with the frequency resources associated with the uplink BWP.

The transmission component 1104 may transmit the downlink communication using a subset of the frequency resources associated with the downlink sub-band that overlap with the frequency resources associated with the downlink BWP.

The transmission component 1104 may transmit a configuration of the specific subcarrier spacing.

The transmission component 1104 may transmit a configuration of the downlink BWP.

The transmission component 1104 may transmit a configuration of multiple downlink sub-bands, wherein the multiple downlink sub-bands are associated with at least a minimum number of downlink resource blocks.

The reception component 1102 and/or the transmission component 1104 may perform at least one of receiving the uplink communication outside of the uplink sub-band or transmitting the downlink communication outside of the downlink sub-band.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a UE, comprising: receiving a first configuration of at least one of an uplink BWP or a downlink BWP; receiving a second configuration of at least one of an uplink sub-band or a downlink sub-band; and identifying at least one of frequency resources associated with transmitting an uplink communication or frequency resources associated with receiving a downlink communication based at least in part on the first configuration and the second configuration.

Aspect 2: The method of Aspect 1, wherein the at least one of the uplink sub-band or the downlink sub-band is associated with a sub-band full duplex symbol.

Aspect 3: The method of any of Aspects 1-2, wherein the first configuration includes a configuration of the uplink BWP, wherein the second configuration includes a configuration of the uplink sub-band, and wherein frequency resources associated with the uplink BWP contain frequency resources associated with the uplink sub-band.

Aspect 4: The method of any of Aspects 1-3, wherein the first configuration includes a configuration of the uplink BWP, wherein the second configuration includes a configuration of the uplink sub-band, and wherein frequency resources associated with the uplink BWP at least partially overlap with frequency resources associated with the uplink sub-band.

Aspect 5: The method of Aspect 4, wherein the frequency resources associated with the uplink BWP at least partially overlap with the frequency resources associated with the uplink sub-band by at least a minimum overlap amount.

Aspect 6: The method of Aspect 4, further comprising transmitting the uplink communication using a subset of the frequency resources associated with the uplink sub-band that overlap with the frequency resources associated with the uplink BWP.

Aspect 7: The method of Aspect 4, further comprising refraining from transmitting the uplink communication based at least in part on the uplink communication being scheduled outside of a subset of the frequency resources associated with the uplink sub-band that overlap with the frequency resources associated with the uplink BWP.

Aspect 8: The method of Aspect 4, further comprising adjusting the uplink BWP such that the frequency resources associated with the uplink BWP contain the frequency resources associated with the uplink sub-band.

Aspect 9: The method of any of Aspects 1-2, wherein the first configuration includes a configuration of the uplink BWP, wherein the second configuration includes a configuration of the uplink sub-band, and wherein frequency resources associated with the uplink BWP do not overlap with frequency resources associated with the uplink sub-band.

Aspect 10: The method of Aspect 9, further comprising refraining from transmitting the uplink communication based at least in part on the frequency resources associated with the uplink BWP not overlapping with the frequency resources associated with the uplink sub-band.

Aspect 11: The method of Aspect 9, further comprising adjusting the uplink BWP such that the frequency resources associated with the uplink BWP contain the frequency resources associated with the uplink sub-band.

Aspect 12: The method of any of Aspects 1-11, wherein the first configuration includes a configuration of the downlink BWP, wherein the second configuration includes a configuration of the downlink sub-band, and wherein frequency resources associated with the downlink BWP contain frequency resources associated with the downlink sub-band.

Aspect 13: The method of any of Aspects 1-12, wherein the first configuration includes a configuration of the downlink BWP, wherein the second configuration includes a configuration of the downlink sub-band, and wherein frequency resources associated with the downlink BWP at least partially overlap with frequency resources associated with the downlink sub-band.

Aspect 14: The method of Aspect 13, wherein the frequency resources associated with the downlink BWP at least partially overlap with the frequency resources associated with the downlink sub-band by at least a minimum overlap amount.

Aspect 15: The method of Aspect 13, further comprising receiving the downlink communication using a subset of the frequency resources associated with the downlink sub-band that overlap with the frequency resources associated with the downlink BWP.

Aspect 16: The method of Aspect 13, further comprising refraining from receiving the downlink communication based at least in part on the downlink communication being scheduled outside of a subset of the frequency resources associated with the downlink sub-band that overlap with the frequency resources associated with the downlink BWP.

Aspect 17: The method of any of Aspects 1-11, wherein the first configuration includes a configuration of the downlink BWP, wherein the second configuration includes a configuration of the downlink sub-band, and wherein frequency resources associated with the downlink BWP do not overlap with frequency resources associated with the downlink sub-band.

Aspect 18: The method of Aspect 17, further comprising refraining from receiving the downlink communication based at least in part on the frequency resources associated with the downlink BWP not overlapping with the frequency resources associated with the downlink sub-band.

Aspect 19: The method of any of Aspects 1-18, wherein the second configuration is based at least in part on a specific subcarrier spacing.

Aspect 20: The method of Aspect 19, wherein the second configuration is further based at least in part on an offset from an absolute frequency position of a reference resource block.

Aspect 21: The method of Aspect 19, wherein the specific subcarrier spacing is based at least in part on a frequency band associated with the at least one of the uplink BWP or the downlink BWP.

Aspect 22: The method of Aspect 19, further comprising receiving a configuration of the specific subcarrier spacing.

Aspect 23: The method of Aspect 22, wherein the configuration of the specific subcarrier spacing is based at least in part on a common subcarrier spacing parameter associated with a master information block.

Aspect 24: The method of Aspect 19, wherein the specific subcarrier spacing is different than a subcarrier spacing associated with the at least one of the uplink BWP or the downlink BWP, wherein a PRB associated with the at least one of the uplink BWP or the downlink BWP only partially overlaps with the at least one of the uplink sub-band or the downlink sub-band based at least in part on the specific subcarrier spacing being different than the subcarrier spacing associated with the at least one of the uplink BWP or the downlink BWP, and wherein frequency resources associated with the PRB are not used for communication based at least in part on the PRB only partially overlapping with the at least one of the at least one of the uplink sub-band or the downlink sub-band.

Aspect 25: The method of any of Aspects 1-24, wherein the second configuration is based at least in part on an offset parameter associated with a subcarrier spacing associated with the at least one of the uplink BWP or the downlink BWP.

Aspect 26: The method of any of Aspects 1-25, wherein the at least one of the uplink sub-band or the downlink sub-band is associated with at least a minimum number of frequency resources.

Aspect 27: The method of any of Aspects 1-26, further comprising: receiving a configuration of the downlink BWP; and receiving a configuration of multiple downlink sub-bands, wherein the multiple downlink sub-bands are associated with at least a minimum number of downlink resource blocks.

Aspect 28: The method of any of Aspects 1-27, further comprising performing at least one of transmitting the uplink communication outside of the uplink sub-band or receiving the downlink communication outside of the downlink sub-band.

Aspect 29: A method of wireless communication performed by a network node, comprising: transmitting a first configuration of at least one of an uplink BWP or a downlink BWP; transmitting a second configuration of at least one of an uplink sub-band or a downlink sub-band; and identifying at least one of frequency resources associated with receiving an uplink communication or frequency resources associated with transmitting a downlink communication based at least in part on the first configuration and the second configuration.

Aspect 30: The method of Aspect 29, wherein the at least one of the uplink sub-band or the downlink sub-band is associated with a sub-band full duplex symbol.

Aspect 31: The method of any of Aspects 29-30, wherein the first configuration includes a configuration of the uplink BWP, wherein the second configuration includes a configuration of the uplink sub-band, and wherein frequency resources associated with the uplink BWP contain frequency resources associated with the uplink sub-band.

Aspect 32: The method of any of Aspects 29-31, wherein the first configuration includes a configuration of the uplink BWP, wherein the second configuration includes a configuration of the uplink sub-band, and wherein frequency resources associated with the uplink BWP at least partially overlap with frequency resources associated with the uplink sub-band.

Aspect 33: The method of Aspect 32, wherein the frequency resources associated with the uplink BWP at least partially overlap with the frequency resources associated with the uplink sub-band by at least a minimum overlap amount.

Aspect 34: The method of Aspect 32, further comprising receiving the uplink communication using a subset of the frequency resources associated with the uplink sub-band that overlap with the frequency resources associated with the uplink BWP.

Aspect 35: The method of any of Aspects 29-30, wherein the first configuration includes a configuration of the uplink BWP, wherein the second configuration includes a configuration of the uplink sub-band, and wherein frequency resources associated with the uplink BWP do not overlap with frequency resources associated with the uplink sub-band.

Aspect 36: The method of any of Aspects 29-35, wherein the first configuration includes a configuration of the downlink BWP, wherein the second configuration includes a configuration of the downlink sub-band, and wherein frequency resources associated with the downlink BWP contain frequency resources associated with the downlink sub-band.

Aspect 37: The method of any of Aspects 29-36, wherein the first configuration includes a configuration of the downlink BWP, wherein the second configuration includes a configuration of the downlink sub-band, and wherein frequency resources associated with the downlink BWP at least partially overlap with frequency resources associated with the downlink sub-band.

Aspect 38: The method of Aspect 37, wherein the frequency resources associated with the downlink BWP at least partially overlap with the frequency resources associated with the downlink sub-band by at least a minimum overlap amount.

Aspect 39: The method of Aspect 38, further comprising transmitting the downlink communication using a subset of the frequency resources associated with the downlink sub-band that overlap with the frequency resources associated with the downlink BWP.

Aspect 40: The method of any of Aspects 29-35, wherein the first configuration includes a configuration of the downlink BWP, wherein the second configuration includes a configuration of the downlink sub-band, and wherein frequency resources associated with the downlink BWP do not overlap with frequency resources associated with the downlink sub-band.

Aspect 41: The method of any of Aspects 29-40, wherein the second configuration is based at least in part on a specific subcarrier spacing.

Aspect 42: The method of Aspect 41, wherein the second configuration is further based at least in part on an offset from an absolute frequency position of a reference resource block.

Aspect 43: The method of Aspect 41, wherein the specific subcarrier spacing is based at least in part on a frequency band associated with the at least one of the uplink BWP or the downlink BWP.

Aspect 44: The method of Aspect 41, further comprising transmitting a configuration of the specific subcarrier spacing.

Aspect 45: The method of Aspect 44, wherein the configuration of the specific subcarrier spacing is based at least in part on a common subcarrier spacing parameter associated with a master information block.

Aspect 46: The method of Aspect 41, wherein the specific subcarrier spacing is different than a subcarrier spacing associated with the at least one of the uplink BWP or the downlink BWP, wherein a PRB associated with the at least one of the uplink BWP or the downlink BWP only partially overlaps with the at least one of the uplink sub-band or the downlink sub-band based at least in part on the specific subcarrier spacing being different than the subcarrier spacing associated with the at least one of the uplink BWP or the downlink BWP, and wherein frequency resources associated with the PRB are not used for communication based at least in part on the PRB only partially overlapping with the at least one of the at least one of the uplink sub-band or the downlink sub-band.

Aspect 47: The method of any of Aspects 29-46, wherein the second configuration is based at least in part on an offset parameter associated with a subcarrier spacing associated with the at least one of the uplink BWP or the downlink BWP.

Aspect 48: The method of any of Aspects 29-47, wherein the at least one of the uplink sub-band or the downlink sub-band is associated with at least a minimum number of frequency resources.

Aspect 49: The method of any of Aspects 29-48, further comprising: transmitting a configuration of the downlink BWP; and transmitting a configuration of multiple downlink sub-bands, wherein the multiple downlink sub-bands are associated with at least a minimum number of downlink resource blocks.

Aspect 50: The method of any of Aspects 29-49, further comprising performing at least one of receiving the uplink communication outside of the uplink sub-band or transmitting the downlink communication outside of the downlink sub-band.

Aspect 51: An apparatus for wireless communication at a device, comprising a processor; memory coupled with the processor; and instructions stored in the memory and executable by the processor to cause the apparatus to perform the method of one or more of Aspects 1-50.

Aspect 52: A device for wireless communication, comprising a memory and one or more processors coupled to the memory, the one or more processors configured to perform the method of one or more of Aspects 1-50.

Aspect 53: An apparatus for wireless communication, comprising at least one means for performing the method of one or more of Aspects 1-50.

Aspect 54: A non-transitory computer-readable medium storing code for wireless communication, the code comprising instructions executable by a processor to perform the method of one or more of Aspects 1-50.

Aspect 55: A non-transitory computer-readable medium storing a set of instructions for wireless communication, the set of instructions comprising one or more instructions that, when executed by one or more processors of a device, cause the device to perform the method of one or more of Aspects 1-50.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A user equipment (UE) for wireless communication, comprising:
one or more memories; and
one or more processors, coupled to the one or more memories, that are individually or collectively configured to:
receive a first configuration of at least one of an uplink bandwidth part (BWP) or a downlink BWP;
receive a second configuration of at least one of an uplink sub-band or a downlink sub-band; and
identify at least one of frequency resources associated with transmitting an uplink communication or frequency resources associated with receiving a downlink communication based at least in part on the first configuration and the second configuration.

2. The UE of claim 1, wherein the at least one of the uplink sub-band or the downlink sub-band is associated with a sub-band full duplex symbol.

3. The UE of claim 1, wherein the first configuration includes a configuration of the uplink BWP,
wherein the second configuration includes a configuration of the uplink sub-band, and
wherein frequency resources associated with the uplink BWP contain frequency resources associated with the uplink sub-band.

4. The UE of claim 1, wherein the first configuration includes a configuration of the uplink BWP,
wherein the second configuration includes a configuration of the uplink sub-band, and
wherein frequency resources associated with the uplink BWP at least partially overlap with frequency resources associated with the uplink sub-band.

5. The UE of claim 4, wherein the frequency resources associated with the uplink BWP at least partially overlap with the frequency resources associated with the uplink sub-band by at least a minimum overlap amount.

6. The UE of claim 4, wherein the one or more processors are further configured to transmit the uplink communication using a subset of the frequency resources associated with the uplink sub-band that overlap with the frequency resources associated with the uplink BWP.

7. The UE of claim 4, wherein the one or more processors are further configured to refrain from transmitting the uplink communication based at least in part on the uplink communication being scheduled outside of a subset of the frequency resources associated with the uplink sub-band that overlap with the frequency resources associated with the uplink BWP.

8. The UE of claim 1, wherein the first configuration includes a configuration of the uplink BWP,
wherein the second configuration includes a configuration of the uplink sub-band, and
wherein frequency resources associated with the uplink BWP do not overlap with frequency resources associated with the uplink sub-band.

9. The UE of claim 8, wherein the one or more processors are further configured to refrain from transmitting the uplink communication based at least in part on the frequency resources associated with the uplink BWP not overlapping with the frequency resources associated with the uplink sub-band.

10. The UE of claim 1, wherein the first configuration includes a configuration of the downlink BWP,
wherein the second configuration includes a configuration of the downlink sub-band, and
wherein frequency resources associated with the downlink BWP contain frequency resources associated with the downlink sub-band.

11. The UE of claim 1, wherein the first configuration includes a configuration of the downlink BWP,
wherein the second configuration includes a configuration of the downlink sub-band, and
wherein frequency resources associated with the downlink BWP at least partially overlap with frequency resources associated with the downlink sub-band.

12. The UE of claim 11, wherein the frequency resources associated with the downlink BWP at least partially overlap with the frequency resources associated with the downlink sub-band by at least a minimum overlap amount.

13. The UE of claim 11, wherein the one or more processors are further configured to receive the downlink communication using a subset of the frequency resources associated with the downlink sub-band that overlap with the frequency resources associated with the downlink BWP.

14. The UE of claim 11, wherein the one or more processors are further configured to refrain from receiving the downlink communication based at least in part on the downlink communication being scheduled outside of a subset of the frequency resources associated with the downlink sub-band that overlap with the frequency resources associated with the downlink BWP.

15. The UE of claim 1, wherein the first configuration includes a configuration of the downlink BWP,
wherein the second configuration includes a configuration of the downlink sub-band, and
wherein frequency resources associated with the downlink BWP do not overlap with frequency resources associated with the downlink sub-band.

16. The UE of claim 15, wherein the one or more processors are further configured to refrain from receiving the downlink communication based at least in part on the frequency resources associated with the downlink BWP not overlapping with the frequency resources associated with the downlink sub-band.

17. The UE of claim 1, wherein the second configuration is based at least in part on a specific subcarrier spacing.

18. The UE of claim 17, wherein the second configuration is further based at least in part on an offset from an absolute frequency position of a reference resource block.

19. The UE of claim 17, wherein the specific subcarrier spacing is based at least in part on a frequency band associated with the at least one of the uplink BWP or the downlink BWP.

20. The UE of claim 17, wherein the one or more processors are further configured to receive a configuration of the specific subcarrier spacing.

21. The UE of claim 20, wherein the configuration of the specific subcarrier spacing is based at least in part on a common subcarrier spacing parameter associated with a master information block.

22. The UE of claim 17, wherein the specific subcarrier spacing is different than a subcarrier spacing associated with the at least one of the uplink BWP or the downlink BWP,
wherein a physical resource block (PRB) associated with the at least one of the uplink BWP or the downlink BWP only partially overlaps with the at least one of the uplink sub-band or the downlink sub-band based at least in part on the specific subcarrier spacing being different than the subcarrier spacing associated with the at least one of the uplink BWP or the downlink BWP, and
wherein frequency resources associated with the PRB are not used for communication based at least in part on the PRB only partially overlapping with the at least one of the at least one of the uplink sub-band or the downlink sub-band.

23. The UE of claim 1, wherein the second configuration is based at least in part on an offset parameter associated with a subcarrier spacing associated with the at least one of the uplink BWP or the downlink BWP.

24. The UE of claim 1, wherein the at least one of the uplink sub-band or the downlink sub-band is associated with at least a minimum number of frequency resources.

25. The UE of claim 1, wherein the one or more processors are further configured to:
receive a configuration of the downlink BWP; and
receive a configuration of multiple downlink sub-bands, wherein the multiple downlink sub-bands are associated with at least a minimum number of downlink resource blocks.

26. The UE of claim 1, wherein the one or more processors are further configured to perform at least one of transmitting the uplink communication outside of the uplink sub-band or receiving the downlink communication outside of the downlink sub-band.

27. A network node for wireless communication, comprising:
one or more memories; and
one or more processors, coupled to the one or more memories, that are individually or collectively configured to:
transmit a first configuration of at least one of an uplink bandwidth part (BWP) or a downlink BWP;
transmit a second configuration of at least one of an uplink sub-band or a downlink sub-band; and
identify at least one of frequency resources associated with receiving an uplink communication or frequency resources associated with transmitting a downlink communication based at least in part on the first configuration and the second configuration.

28. The network node of claim 27, wherein the at least one of the uplink sub-band or the downlink sub-band is associated with a sub-band full duplex symbol.

29. A method of wireless communication performed by a user equipment (UE), comprising:
receiving a first configuration of at least one of an uplink bandwidth part (BWP) or a downlink BWP;
receiving a second configuration of at least one of an uplink sub-band or a downlink sub-band; and
identifying at least one of frequency resources associated with transmitting an uplink communication or frequency resources associated with receiving a downlink communication based at least in part on the first configuration and the second configuration.

30. A method of wireless communication performed by a network node, comprising:
transmitting a first configuration of at least one of an uplink bandwidth part (BWP) or a downlink BWP;
transmitting a second configuration of at least one of an uplink sub-band or a downlink sub-band; and
identifying at least one of frequency resources associated with receiving an uplink communication or frequency resources associated with transmitting a downlink communication based at least in part on the first configuration and the second configuration.
